(19) United States
(12) Patent Application Publication
(10) Pub. No.: US 2023/0419255 A1
(43) Pub. Date: Dec. 28, 2023

(54) FLOW DECOMPOSITION METHOD

(71) Applicant: Hitachi, Ltd., Chiyoda-ku (JP)

(72) Inventors: Qi XIU, Mountain View, CA (US); Kazuhide AIKOH, Santa Clara, CA (US)

(21) Appl. No.: 17/851,935

(22) Filed: Jun. 28, 2022

(51) Int. Cl. G06Q 10/08; G06Q 10/06

(52) U.S. Cl. CPC G06Q 10/0875; G06Q 10/06375; G06Q 10/06315

(57) ABSTRACT

A method for supply chain construction. The method may include, for receipt of a search for a specified company, obtaining a supplier list and sales information for a plurality of companies associated with the specified company; tracing purchased components and suppliers of the purchased components by item category from supplier-buyer relationship in the supplier list to generate a supply web; calculating sales ratios using the supplier-buyer relationship and the sales information; calculating component probability of the purchased components in association with a plurality of products by using the sales ratios, wherein each of the plurality of product is formed from a number of the purchased components; estimating product-component relationship using the supply web and the component probability for the plurality of products and the purchased components; and generating product specific supply chain associated with the purchased components and the suppliers for the specified company.

### BACKGROUND

### Field

The present disclosure is generally directed to methods of supply chain construction, software-module chain construction, and cash flow monitoring.

### Related Art

In the New Normal, with growing risks of supply chain disruptions caused by incidents such as natural disaster and COVID-19 pandemic, companies need continuous supply chain analysis and dynamic component vendor replacement.

FIG. 1 illustrated automobile production halt as result of chip-shortage. Even though the chip factory is neither the automobile manufacturer's supplier nor customer, automobile components are affected by the downstream shortage of automobile chips, which in turn impacts automobile manufacturer's productions. As illustrated, disruption at any company in the supply chain of a final product could result in a major impact in the supply chain. Therefore, an End-to-end (E2E) supply chain tracing is required for continuous supply chain analysis.

Furthermore, companies that manufacture multiple products need to decompose their supply chains by product so that component vendors can be replaced when supply chain encounters disruptions caused by incidents.

In the related art, various methods for constructing supply chain model based on event data generated in real business activities exist. These methods include using electronic data interchange (EDI) messages to link suppliers and buyers for inter-organizationally generated business models, using radio frequency identification (RFID) to generate model of supply chain linking suppliers and buyers, as well as using bill-of-material (BOM) to establish relationships between assemblies, sub-assemblies, and final products to link components and products.

However, the methods utilized in the related art fail to generate end-to-end (E2E) supply chain identifying component-supplier relationships for each product. Object linkage (also known as record linkage, data matching, entity resolution, and etc.) is the task of finding objects in different data sources that refer to the same object. Specifically, two types of relationships are required to generate the process model of an E2E supply chain: relationship between suppliers-buyers and relationship between final product and its components.

In related art, order number in EDI messages and RFID are used to specify relationship between buyers and suppliers for inter-organizational supply chain construction. However, components and final product use different order number or RFID. As a result, relationship between final product and its components cannot be generated based on EDI messages or RFID. On the other hand, while BOM may be used to specify relationship between final product and its components, BOM cannot be used to specify linkage between suppliers and buyers.

Furthermore, the combination of EDI/RFID and BOM still cannot generate E2E supply chain identifying component-supplier relationship for each product. Specifically, linkage in EDURFID is by order or individual product, while linkage in BOM is by product category.

Therefore, a decomposition method such as an E2E product specific supply chain identifying component-supplier relationships for each product, becomes necessary for continuous supply chain analysis and dynamic component vendor replacement.

### SUMMARY

Aspects of the present disclosure involve an innovative method for supply chain construction. The method may include, for receipt of a search for a specified company, obtaining a supplier list and sales information for a plurality of companies associated with the specified company; tracing purchased components and suppliers of the purchased components by item category from supplier-buyer relationship in the supplier list to generate a supply web; calculating sales ratios using the supplier-buyer relationship and the sales information; calculating component probability of the purchased components in association with a plurality of products by using the sales ratios, wherein each of the plurality of product is formed from a number of the purchased components; estimating product-component relationship using the supply web and the component probability for the plurality of products and the purchased components; and generating product specific supply chain associated with the purchased components and the suppliers for the specified company.

Aspects of the present disclosure involve an innovative method for software-module chain construction. The method may include, obtaining a server-library dependency information for a plurality of servers associated with a library; tracing the plurality of servers and a plurality of modules associated with the library from server-library relationship in the server-library dependency list; calculating output ratios using the server-library relationship and a plurality of server functions; calculating dependency probability of the plurality of servers in association with the plurality of server functions, the plurality of servers, and the plurality of modules; and generating server function-library module relationship associated with the server functions and the library.

Aspects of the present disclosure involve an innovative method for cash flow monitoring. The method may include, obtaining expense information and revenue information associated with a company; calculating revenue ratios using the expense information and the revenue information; calculating correspondence probability of expenses of purchased components in association with revenues of products by using the revenue ratios; and generating revenue-expense relationship associated with the expenses of purchased components and the revenues of products of the company.

Aspects of the present disclosure involve an innovative system for supply chain construction. The system can include, for receipt of a search for a specified company, means for obtaining a supplier list and sales information for a plurality of companies associated with the specified company; means for tracing purchased components and suppliers of the purchased components by item category from supplier-buyer relationship in the supplier list to generate a supply web; means for calculating sales ratios using the supplier-buyer relationship and the sales information; means for calculating component probability of the purchased components in association with a plurality of products by using the sales ratios, wherein each of the plurality of product is formed from a number of the purchased components; means for estimating product-component relationship using the supply web and the component probability for the plurality of products and the purchased components; and means for generating product specific supply chain associated with the purchased components and the suppliers for the specified company.

Aspects of the present disclosure involve an innovative system for software-module chain construction. The system can include, means for obtaining a server-library dependency information for a plurality of servers associated with a library; means for tracing the plurality of servers and a plurality of modules associated with the library from server-library relationship in the server-library dependency list; means for calculating output ratios using the server-library relationship and a plurality of server functions; means for calculating dependency probability of the plurality of servers in association with the plurality of server functions, the plurality of servers, and the plurality of modules; and generating server function-library module relationship associated with the server functions and the library.

Aspects of the present disclosure involve an innovative system for cash flow monitoring. The system can include, means for obtaining expense information and revenue information associated with a company; means for calculating revenue ratios using the expense information and the revenue information; means for calculating correspondence probability of expenses of purchased components in association with revenues of products by using the revenue ratios; and means for generating revenue-expense relationship associated with the expenses of purchased components and the revenues of products of the company.

### BRIEF DESCRIPTION OF DRAWINGS

A general architecture that implements the various features of the disclosure will now be described with reference to the drawings. The drawings and the associated descriptions are provided to illustrate example implementations of the disclosure and not to limit the scope of the disclosure. Throughout the drawings, reference numbers are reused to indicate correspondence between referenced elements.

FIG. 1 illustrated an example scenario of automobile production halt as result of chip-shortage.

FIG. 2 illustrates an outline block diagram of a supply chain construction system.

FIG. 3 illustrates the input and output of supply web generation server 110 in accordance with an example implementation.

FIG. 4 illustrates an example of the supplier list table 210 in accordance with an example implementation.

FIG. 5 illustrates an example of the buyer-supplier relationships company table 230-A of Alpha Building Systems, in accordance with an example implementation.

FIG. 6 illustrates an example of the buyer-supplier relationships company table 230-B of Alpha High Tech, in accordance with an example implementation.

FIG. 7 illustrates an example of the supply web table of target company 240, in accordance with an example implementation.

FIG. 8 illustrates an example of the product category list table of target company 250, in accordance with an example implementation.

FIG. 9 illustrates the input and output of product-component relationship estimation server 120.

FIG. 10 illustrates an example of the sales report table 220 of the target company, in accordance with an example implementation.

FIG. 11 illustrates an example of the sales ratio table 310, in accordance with an example implementation.

FIG. 12 illustrates an example of the component probability table 320, in accordance with an example implementation.

FIG. 13 illustrates an example of the product-component relationship table 330, in accordance with an example implementation.

FIG. 14 illustrates the product specific supply chain construction server clustering the supply web of target company by product category and organizing by tiers.

FIG. 15 illustrates an example of the product-specific supply chain table of target company 340, in accordance with an example implementation.

FIG. 16 illustrates a general flow chart of an example supply chain construction system 100, in accordance with an example implementation.

FIG. 17 illustrates a flow chart of an example supply web generation server 110, in accordance with an example implementation.

FIG. 18 illustrates a flow chart of a product category list generation unit 112, in accordance with an example implementation.

FIG. 19 illustrates a flow chart of a product-component relationship estimation server 120, in accordance with an example implementation.

FIG. 20 illustrates a flow chart of a sales ratio calculation unit 121, in accordance with an example implementation.

FIG. 21 illustrates a flow chart of a component probability calculation unit 122, in accordance with an example implementation.

FIG. 22 illustrates a flow chart of product specific supply chain construction server 130, in accordance with an example implementation.

FIG. 23 illustrates a flow chart of a tier organization unit 132, in accordance with an example implementation.

FIG. 24 illustrates an example graphic user interface (GUI) for inputting target company name and displaying the result of linking supplier-buyer relationship with product-component relationship utilizing globally universal item code, in accordance with an example implementation.

FIG. 25 illustrates an example software-module chain information flow decomposition, in accordance with an example implementation.

FIG. 26 illustrates an example server-library dependency table, in accordance with an example implementation.

FIG. 27 illustrates an example server-library dependency table of HiNext, in accordance with an example implementation.

FIG. 28 illustrates an example server-library dependency table of Concur, in accordance with an example implementation.

FIG. 29 illustrates an example sever function output ratio table, in accordance with an example implementation.

FIG. 30 illustrates an example server function-library module dependency probability table, in accordance with an example implementation.

FIG. 31 illustrates an example server function-library module relationship table, in accordance with an example implementation.

FIG. 32 illustrates an example of cash flow decomposition, in accordance with an example implementation.

FIG. 33 illustrates an example expense table, in accordance with an example implementation.

FIG. 34 illustrates an example expense table for Alpha Building Systems, in accordance with an example implementation.

FIG. 35 illustrates an example expense table for Beta Elevator, in accordance with an example implementation.

FIG. 36 illustrates an example expense table for Alpha High Tech, in accordance with an example implementation.

FIG. 37 illustrates an example revenue table, in accordance with an example implementation.

FIG. 38 illustrates an example revenue table for Alpha Building Systems, in accordance with an example implementation.

FIG. 39 illustrates an example revenue table for Beta Elevator, in accordance with an example implementation.

FIG. 40 illustrates an example revenue table for Alpha High Tech, in accordance with an example implementation.

FIG. 41 illustrates an example revenue ratio table, in accordance with an example implementation.

FIG. 42 illustrates an example revenue-expense correspondence probability table, in accordance with an example implementation.

FIG. 43 illustrates an example revenue-expense relationship table, in accordance with an example implementation.

FIG. 44 illustrates an example computing environment with an example computer device suitable for use in some example implementations.

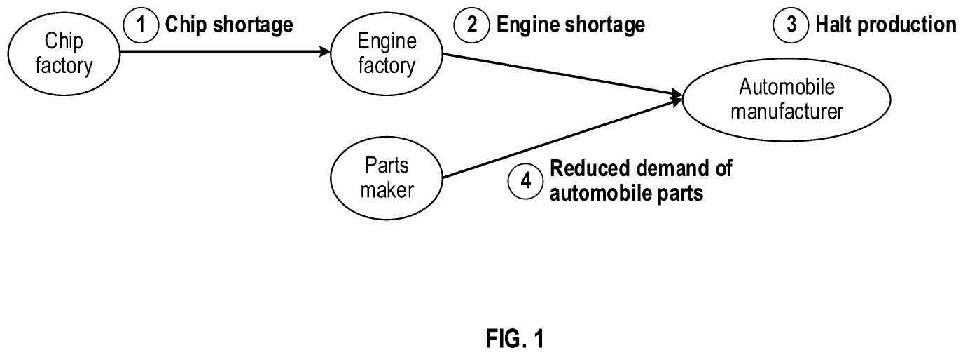

### DETAILED DESCRIPTION

The following detailed description following detailed description provides details of the figures and example implementations of the present application. Reference numerals and descriptions of redundant elements between figures are omitted for clarity. Terms used throughout the description are provided as examples and are not intended to be limiting. For example, the use of the term “automatic” may involve fully automatic or semi-automatic implementations involving user or administrator control over certain aspects of the implementation, depending on the desired implementation of one of the ordinary skills in the art practicing implementations of the present application. Selection can be conducted by a user through a user interface or other input means, or can be implemented through a desired algorithm. Example implementations as described herein can be utilized either singularly or in combination and the functionality of the example implementations can be implemented through any means according to the desired implementations.

### Embodiment 1

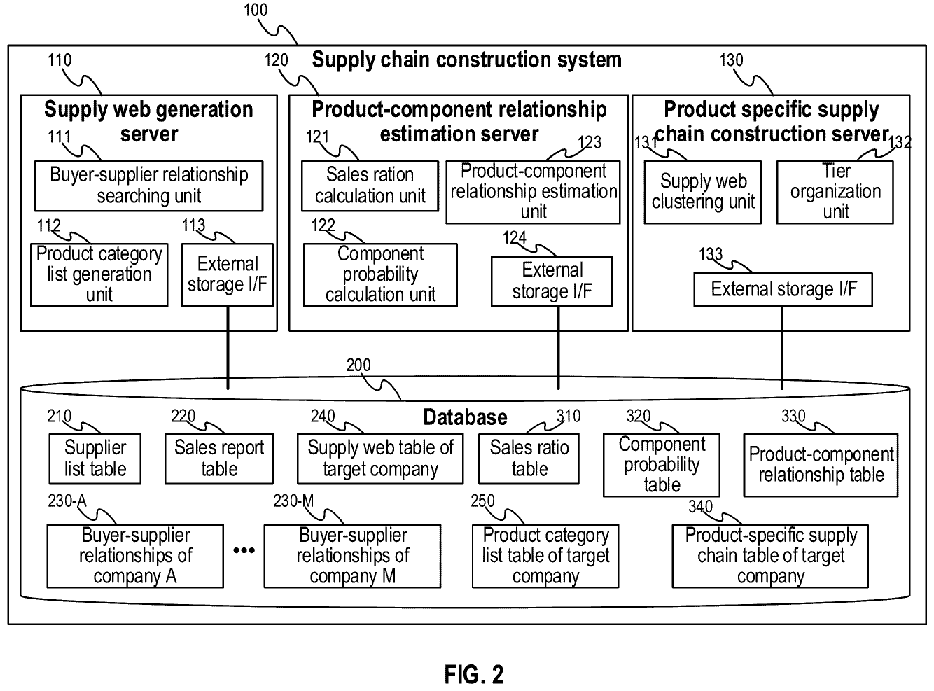

FIG. 2 illustrates an outline block diagram of a supply chain construction system. In the example supply chain construction system 100, there is a supply web generation server 110, a product-component relationship estimation server 120, a product specific supply chain construction server 130, and a database 200. Supply web generation server 110, product-component relationship estimation server 120, and product specific supply chain construction server 130 are all connected to the database 200. The supply web generation server 110 may include a buyer-supplier relationship searching unit 111, a product category list generation unit 112, and an external storage I/F 113. The external storage I/F 113 allows for communication between the supply web generation server 110 and the database 200. The product-component relationship estimation server 120 may include a sales ratio calculation unit 121, a component probability calculation unit 122, a product-component relationship estimation unit 123, and an external storage I/F 124. The external storage I/F 124 allows for communication between the product-component relationship estimation server 120 and the database 200. The product specific supply chain construction server 130 may include a supply web clustering unit 131, a tier organization unit 132, and an external storage I/F 133. The external storage I/F 133 allows for communication between the product specific supply chain construction server 130 and the database 200.

The database 200 stores a supplier list table 210, a sales report table 220, a supply web table of target company 240, a product category list of target company 250, a sales ratio table 310, a component probability table 320, a product-component relationship table, a product-specific supply chain table of target company, and buyer-supplier relationships company tables 230-A to 230-M.

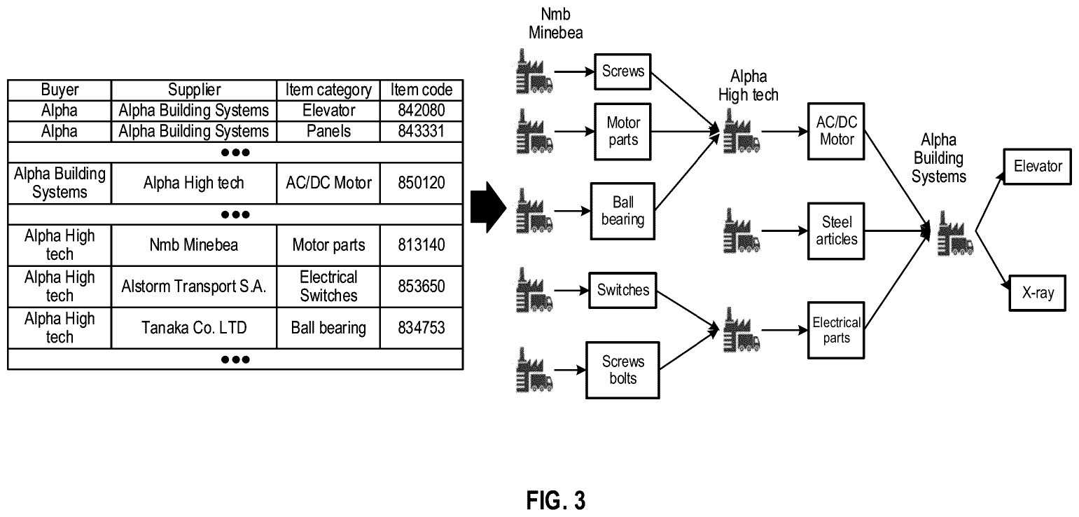

FIG. 3 illustrates the input and output of supply web generation server 110 in accordance with an example implementation. All suppliers of a target company are traced utilizing established supplier-buyer relationships in the supplier list table 210 through the buyer-supplier relationship searching unit 111. All components purchased by the target company or its suppliers are also traced from the supplier list table 210 and grouped by item category. All traced suppliers and purchased components are interlinked to generate a supply web.

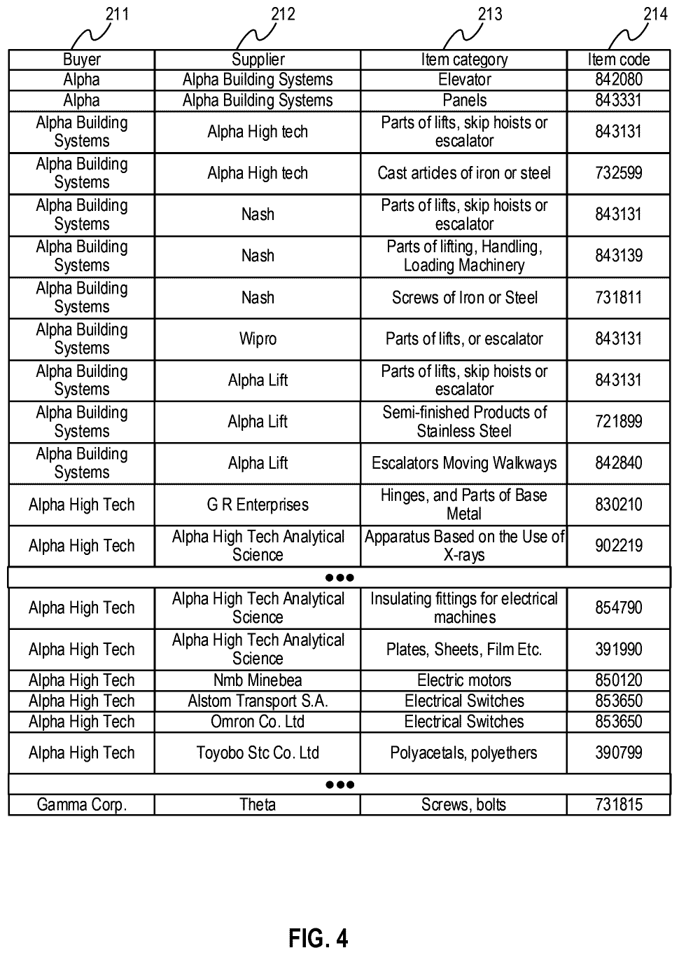

FIG. 4 illustrates an example of the supplier list table 210 in accordance with an example implementation. As illustrated, the supplier list table 210 stores information involving buyer information 211, supplier information 212, item category 213, and item code 214 that relates to the item category 213. Item category 213 relates to the purchased components or products. For example, the first row shows Alpha as the buyer, Alpha Building Systems as the supplier, elevators as the item category, and an associated item code of 842080.

The supplier list table 210 serves as input to the supply web generation server 110, which generates intermediate results in the form of buyer-supplier relationships company tables 230-A to 230-M, and outputs the supply web table of target company 240 and the product category list table of target company 250.

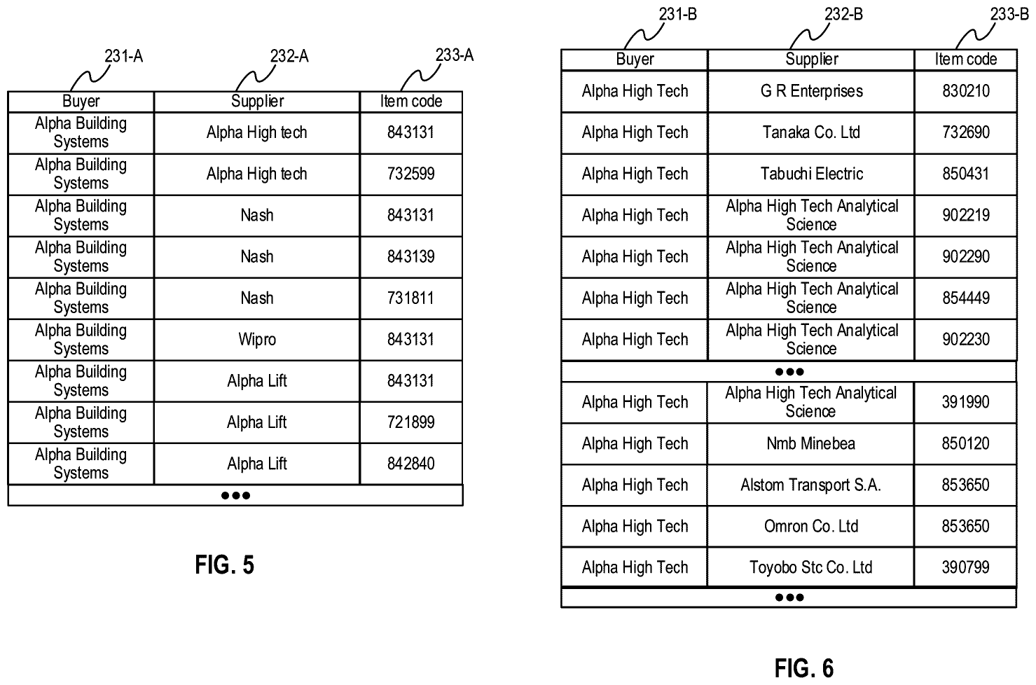

FIG. 5 illustrates an example of the buyer-supplier relationships company table 230-A of Alpha Building Systems, in accordance with an example implementation. The buyer-supplier relationships company table 230-A stores information involving buyer information 231-A, supplier information 232-A, and the associated item code 233-A. Taking row one as example, the buyer is Alpha Building Systems, the supplier is Alpha High Tech, and the associated item code is “843131”.

FIG. 6 illustrates an example of the buyer-supplier relationships company table 230-B of Alpha High Tech, in accordance with an example implementation. The buyer-supplier relationships company table 230-B is similar to the buyer-supplier relationships company table 230-A, however, the buyer-supplier relationships company table 230-B stores information that pertain to Alpha High Tech. The buyer-supplier relationships company table 230-B stores information involving buyer information 231-B, supplier information 232-B, and the associated item code 233-B.

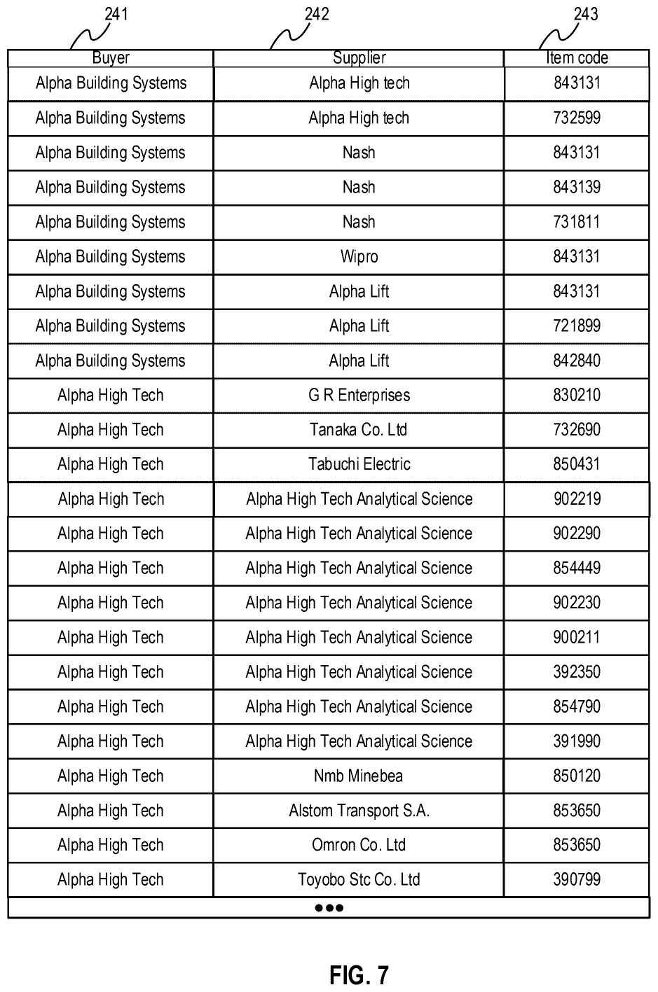

The supply web table of target company 240 and the product category list table of target company 250 are generated as outputs from the supply web generation server 110. FIG. 7 illustrates an example of the supply web table of target company 240, in accordance with an example implementation. The supply web table of target company 240 stores information involving buyer information 241, supplier information 242, and associated item code 243. The supply web table of target company 240 illustrates relationships between the various component suppliers and their downstream part suppliers.

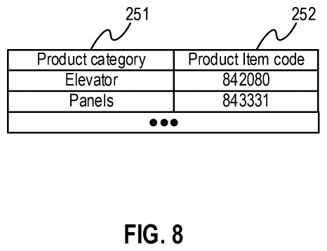

FIG. 8 illustrates an example of the product category list table of target company 250, in accordance with an example implementation. The product category list table of target company 250 stores information involving product category 251 and product item code 252. Product category 251 corresponds to products produced by the target company and product item code 252 corresponds to item codes associated with the products. Taking row one as example, the “Elevator” is shown as the product category and the associated product item code is “842080”. The entries correspond to item category 213 and item code 214 of the supplier list table 210.

The supply web table of target company 240 serves as one of the inputs to the product specific supply chain construction server 130, along with other input such as the component probability table 320 generated from the product-component relationship estimation server 120, which is described in detail below.

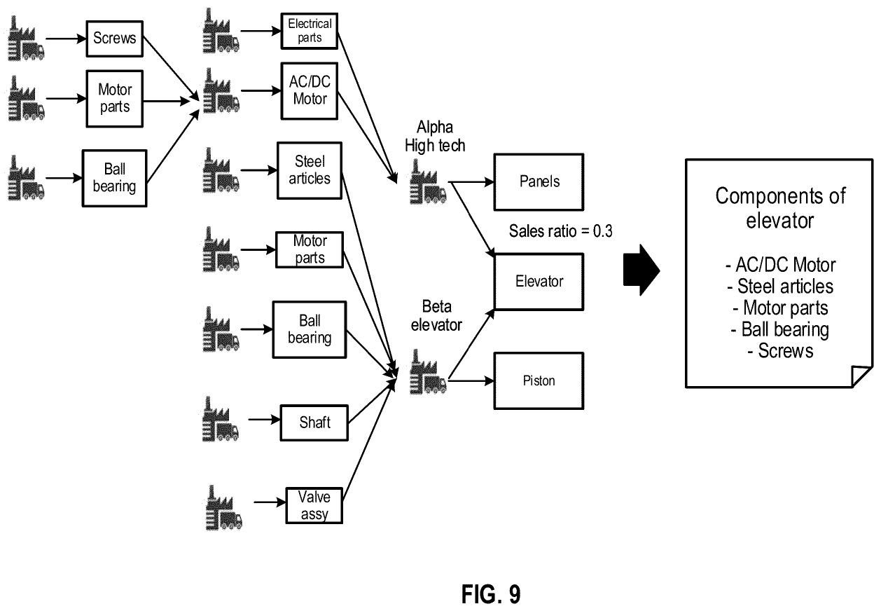

FIG. 9 illustrates the input and output of product-component relationship estimation server 120. Sales ratio of each product category is firstly calculated and stored in the sales ratio table 310. Then, a product-component relationship is estimated according to commonly purchased components of companies supplying the product category. Companies with higher sales ratios of the product category have higher weights on product-component estimation.

Specifically, the product-component relationship estimation server 120 inputs the buyer-supplier relationships tables 230-A to 230M and sales report table 220. The product-component relationship estimation server 120 generates intermediate results in the form of sales ratio table 310 and component probability table 320, and outputs the product-component relationship table 330.

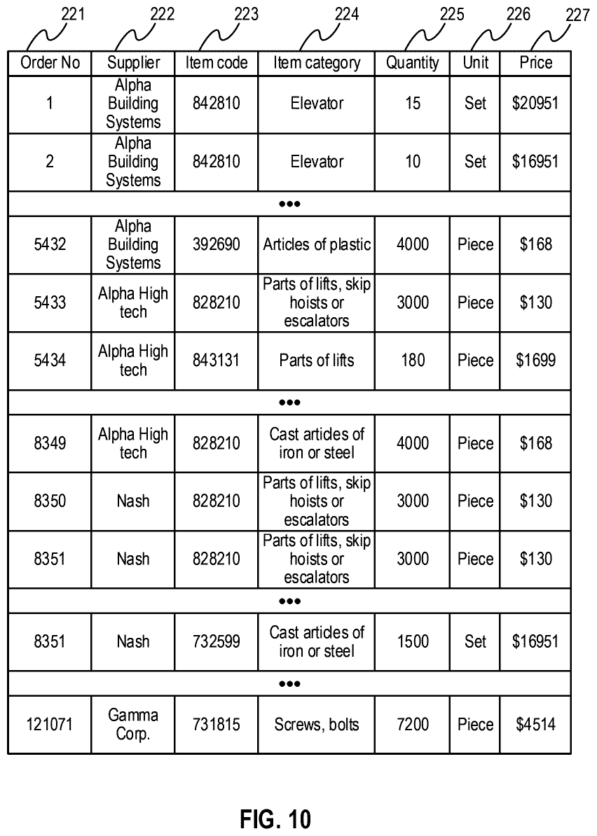

FIG. 10 illustrates an example of the sales report table 220 of the target company, in accordance with an example implementation. The sales report table 220 stores information involving order number 221, supplier information 222, item code 223, item category 224, quantity information 225, unit information 226, and price information 227. Order number 221 is associated with numbers assigned to the different orders between buyers and suppliers. Quantity information 225 relates to number of items as identified in item category 224 that are being supplied. Unit information 226 relates to the specific unit associated with each supplied item. Price information 227 relates to pricing information associated with the order.

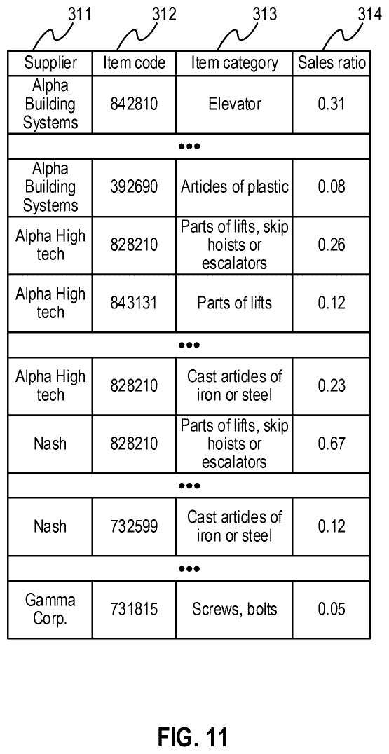

FIG. 11 illustrates an example of the sales ratio table 310, in accordance with an example implementation. The sales ratio table 310 stores information involving supplier information 311, item code 312, item category 313, and sales ratio 314. For target company f, the sales ratio of product pᵢ, where j∈1, 2, . . . , N and represents the number of product item code, is calculated as:

$${r ( f )}_{i} = \frac{{\sum }_{k} F ( f ) i k}{{\sum }_{j = 1}^{N} {\sum }_{k} F ( f ) j k}$$

Here, F(f)ik is the weight of product pᵢ in company f considering features of cost and quantity. Companies with higher sales ratio of the product category have higher weight on product-component estimation.

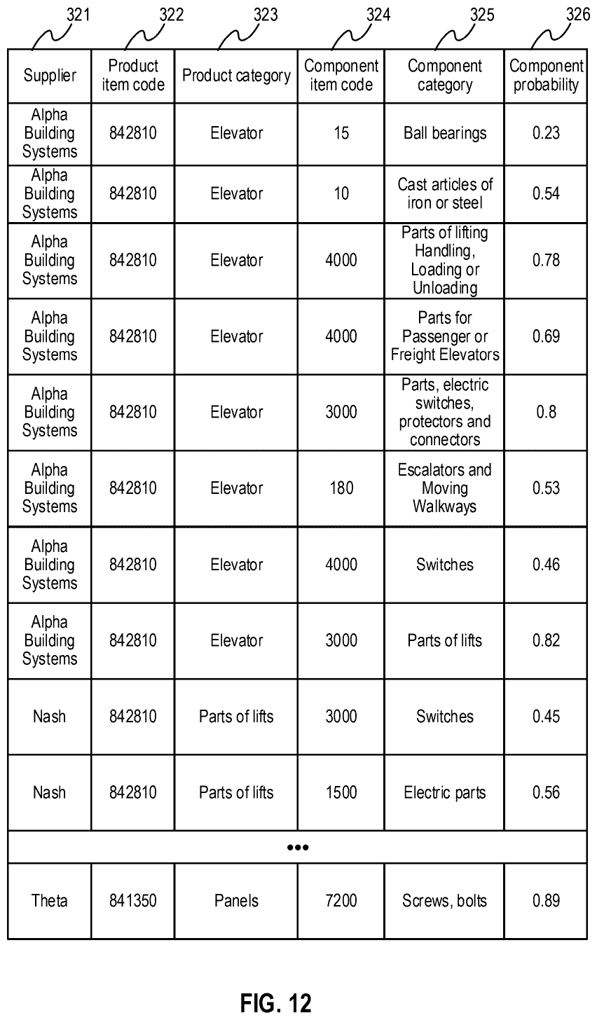

FIG. 12 illustrates an example of the component probability table 320, in accordance with an example implementation. The component probability table 320 stores information involving supplier information 321, product item code 322, product category 323, component item code 324, component category 325, and component probability 326. Product item code 322, product category 323, component item code 324, and component category show the relationship between a product and a component of the product. For target company f importing M components c₁, c₂, . . . , c_{M} and exporting N products p₁, p₂, . . . , p_{N}, calculate the Component Probability CP(f)ᵢⱼ, with cᵢ being the component of product pⱼ, where i∈1, 2, . . . , M and j∈1, 2, . . . , N. Fⱼ refers to the set of factories producing product pⱼ, which includes the target company.

First, CP′(f)ᵢⱼ is initialized to be the quantity ratio of pⱼ to all exports of company f. This is then followed by updating

$${{CP}^{′} ( f )}_{i j} = \frac{{\sum }_{f ∈ {F}_{j}}^{f} {CP ( f )}_{ij}}{{\sum }_{k ∈ 1 , 2 , … , N}^{k} {\sum }_{f ∈ {F}_{i}}^{f} C {P ( f )}_{i k}}$$

iteratively to increase the component probability of parts commonly used by until convergence.

For example, suppose c₁ is AC/DC Motor, p₁ is panels and p₂ is elevator of company Alpha, CP(Alpha)₁₂ would be initialized as 0.5 as it has the same probability to be the component of elevator and Panels. Then, the updates are performed with

$${CP ( Alpha )}_{12} = \frac{{CP ( Alpha )}_{12} + {CP ( Beta )}_{12}}{{CP ( Alpha )}_{12} + {CP ( Beta )}_{12} + {CP ( Alpha )}_{11}} = \frac{0.5 + 0.5}{0.5 + 0.5 + 0.5} = \frac{2}{3}$$

and through iterative updating, CP′(Alpha)₁₂ will converge to 1 (⅘, 8/9, 16/17 . . . ).

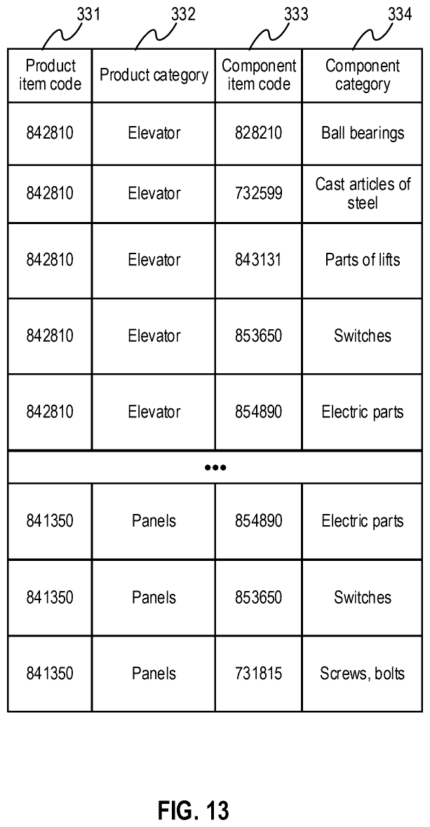

FIG. 13 illustrates an example of the product-component relationship table 330, in accordance with an example implementation. The product-component relationship table 330 is the output generated by the product-component relationship estimation server 120, and stores product item code 331, product category 332, component item code 333, and component category 334.

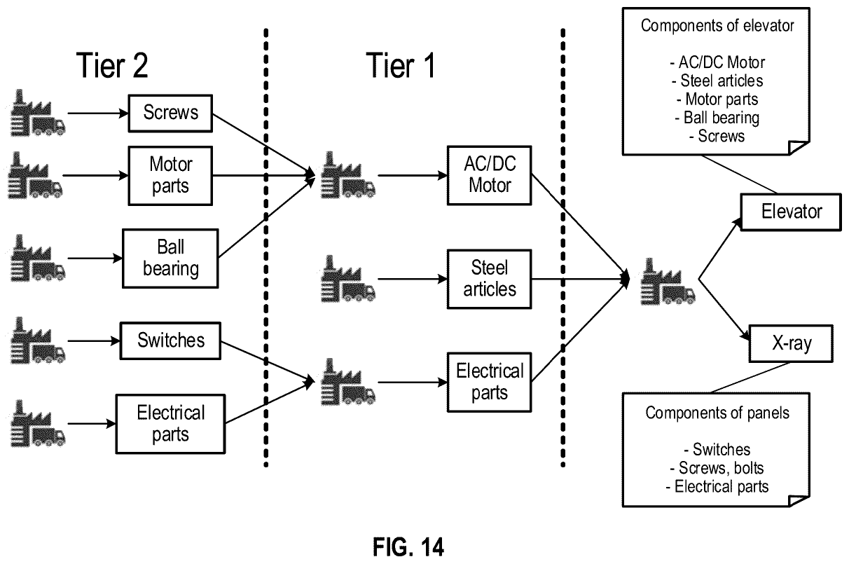

Finally, the product specific supply chain construction server 130 clusters the supply web of target company by product category according to estimated product-component relationship. FIG. 14 illustrates the product specific supply chain construction server clustering the supply web of target company by product category and organizing by tiers. As illustrated in FIG. 14, the supplier-buyer relationship and product component relationship are linked together by item category to generate product specific supply chain. Eventually, all components and suppliers are organized by tier. The input of product specific supply chain construction server 130 is the supply web table of target company 240 and component probability table 320, and the output is product-specific supply chain table of target company 340.

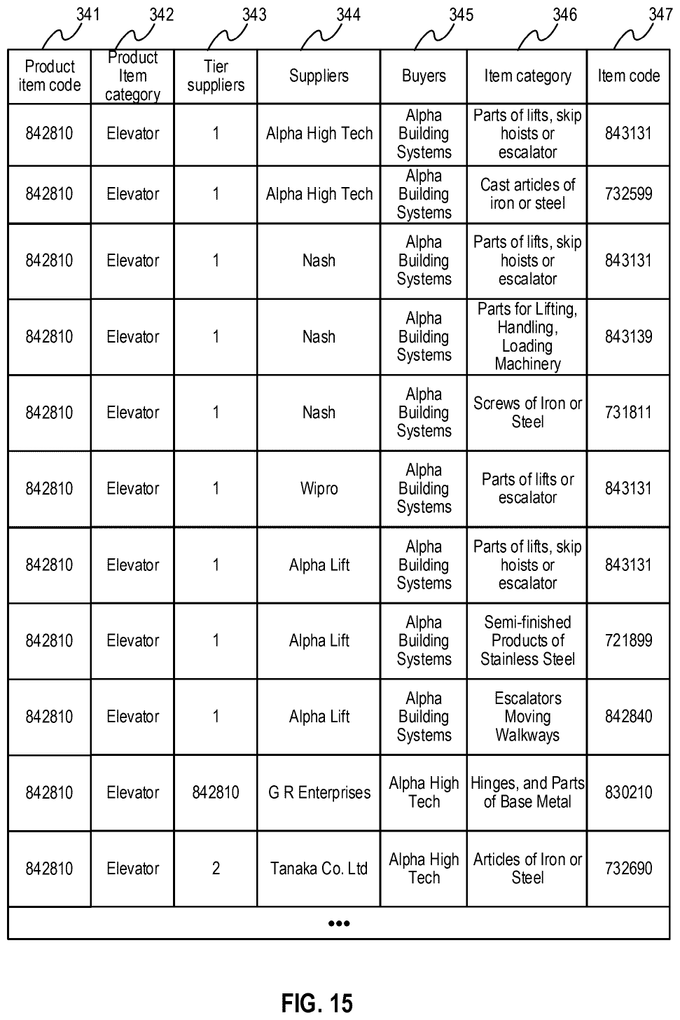

FIG. 15 illustrates an example of the product-specific supply chain table of target company 340, in accordance with an example implementation. The product-specific supply chain table of target company 340 is the output generated by the product specific supply chain construction server, and stores information involving product item code 341, product item category 342, tiers of supplier 343, supplier information 344, buyer information 345, item category 346, and item code 347. The product-specific supply chain table of target company 340 illustrates the full supply chain showing relationships between the various suppliers, buyers, products of the target company, items, and tiering of suppliers.

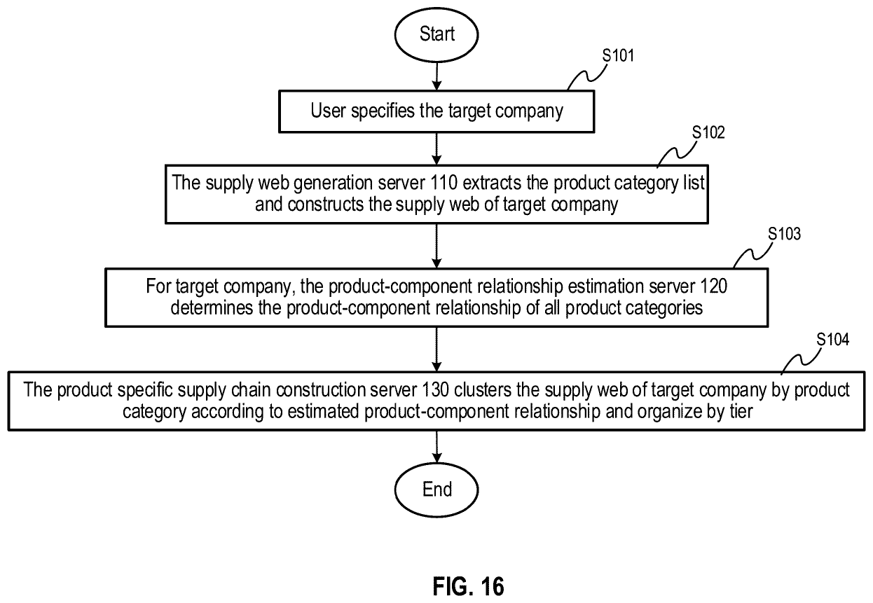

FIG. 16 illustrates a general flow chart of an example supply chain construction system 100, in accordance with an example implementation. At S101, a user specifies the target company. At S102, the supply web generation server 110 extracts the product category list and construct the supply web of the target company. At S103, for the target company, the product-component relationship estimation server 120 determines the product-component relationship of all product categories. At S104, the product specific supply chain construction server 130 clusters the supply web of the target company by product category according to estimated product-component relationship and organize by tier.

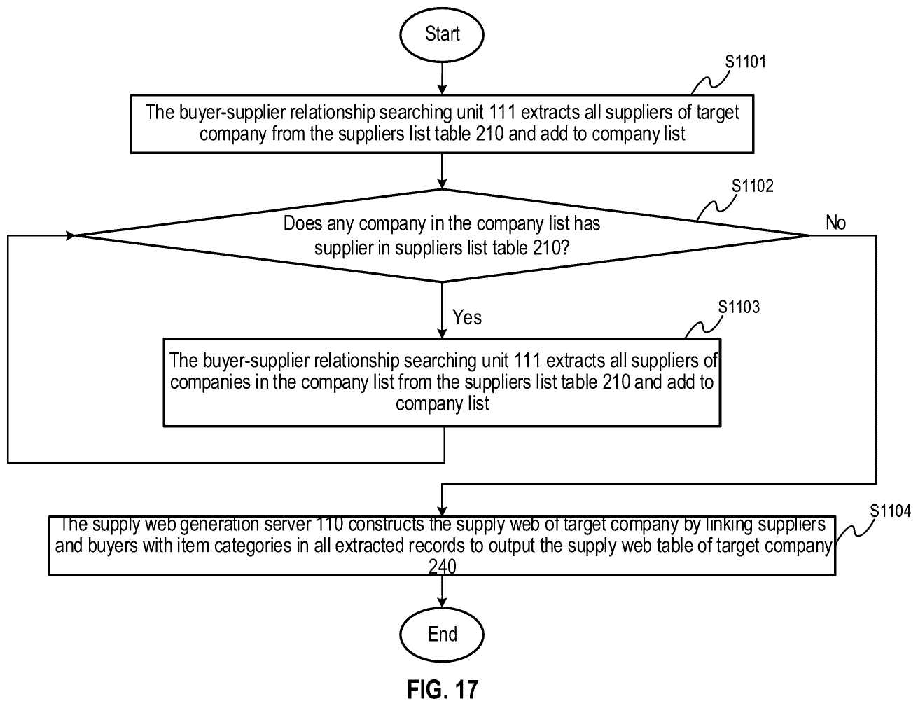

FIG. 17 illustrates a flow chart of an example supply web generation server 110, in accordance with an example implementation. At S1101, the buyer-supplier relationship searching unit 111 extracts all suppliers of the target company from the supplier list table 210 and add to them to the company list. At S1102, it is determined whether any company in the company list has supplier in supplier list table 210. If yes, then the process moves to S1103, where the buyer-supplier relationship searching unit 111 extracts all suppliers of companies in the company list from the supplier list table 210 and add to the company list. After S1103, the process proceeds to S1102 for further determination. If the answer is “no” at S1102, then the supply web generation server 110 constructs the supply web of target company by linking suppliers and buyers with item categories in all extracted records to output the supply web table of target company 240 at S1104.

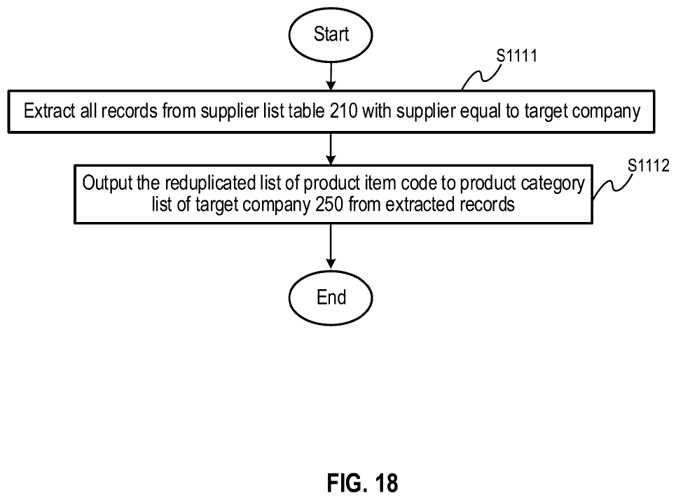

FIG. 18 illustrates a flow chart of a product category list generation unit 112, in accordance with an example implementation. At S1111, all records from supplier list table 210 with supplier equal to target company are extracted. At S1112, the reduplicated list of product item code to product category list of target company 250 from extracted records is outputted.

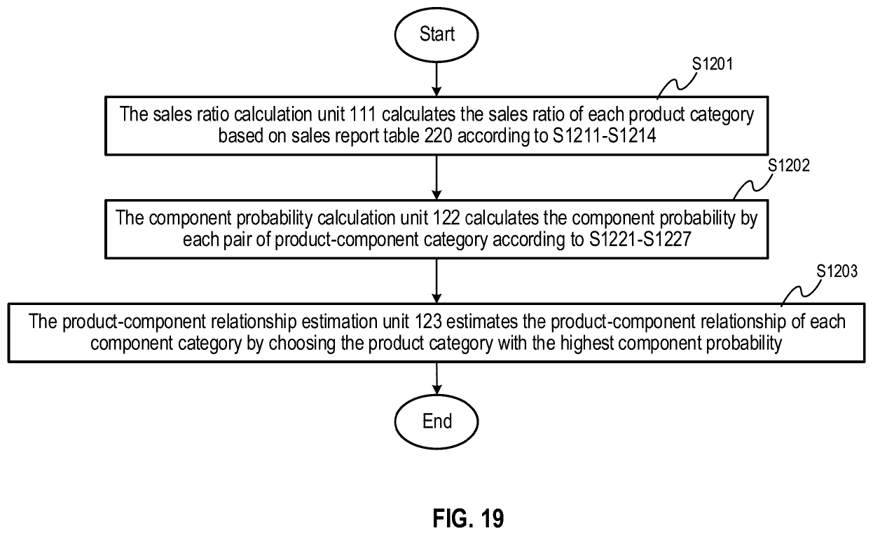

FIG. 19 illustrates a flow chart of a product-component relationship estimation server 120, in accordance with an example implementation. At S1201, the sales ratio calculation unit 121 calculates the sales ratio of each product category based on sales report table 220 according to S1211-S1214. At S1202, the component probability calculation unit 122 calculates the component probability by each pair of product-component category according to S1221-S1227. At S1203, the product-component relationship estimation unit 123 estimates the product-component relationship of each component category by choosing the product category with the highest component probability.

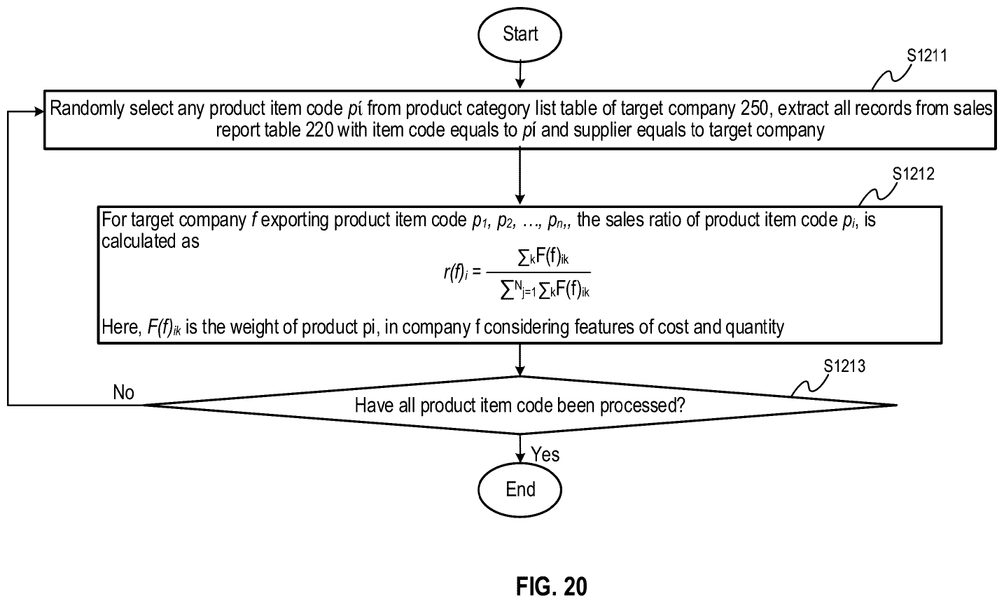

FIG. 20 illustrates a flow chart of a sales ratio calculation unit 121, in accordance with an example implementation. At S1211, randomly select any product item code pⱼ, from product category list table of target company 250, extract all records from sales report table 220 with item code equals to pⱼ, and supplier equals to target company. At S1212, For target company f exporting product item code p₁, p₂, . . . , p_{N}, the sales ratio of product item code pᵢ, is calculated as

$${r ( f )}_{i} = \frac{{\sum }_{k} F ( f ) i k}{{\sum }_{j = 1}^{N} {\sum }_{k} F ( f ) j k}$$

Here, F(f)ik is the weight of product pᵢ in company f considering features of cost and quantity. At S1213, it is determined whether all product item codes have been processed. The process ends if the answer is yes. If the answer is no, then the process proceeds back to S1211.

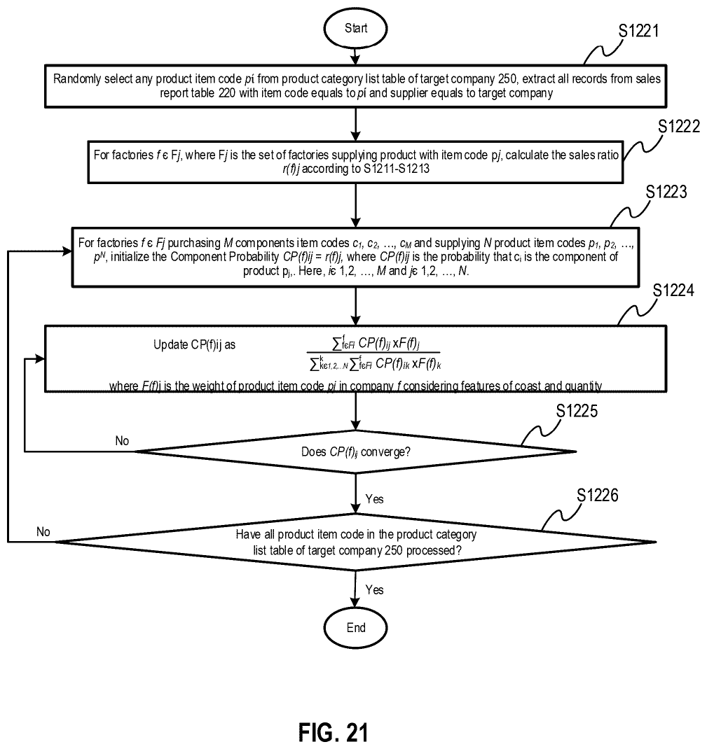

FIG. 21 illustrates a flow chart of a component probability calculation unit 122, in accordance with an example implementation. At S1221, randomly select any product item code pⱼ, from product category list table of target company 250, extract all records from sales report table 220 with item code equals to pⱼ, and supplier equals to target company. At S1222, for factories f∈Fⱼ, where Fⱼ is the set of factories supplying product with item code pⱼ, calculate the sales ratio r(f)ⱼ according to S1211-S1213. At 1223, for factories f∈Fⱼ purchasing M components item codes c₁, c₂, . . . , c_{M} and supplying N product item codes p₁, p₂, . . . , p_{N}, initialize the Component Probability CP(f)ᵢⱼ=r(f)ⱼ, where CP(f)ᵢⱼ is the probability that cᵢ is the component of product pⱼ. Here, i∈1, 2, . . . , M and j∈1, 2, . . . , N.

$$\frac{{\sum }_{f ∈ {F}_{j}}^{f} C P ( f ) i j \times F ( f ) j}{{\sum }_{k ∈ 1 , 2 , … , N}^{k} {\sum }_{f ∈ F j}^{f} C P ( f ) i k \times F ( f ) k}$$

At S1224, Update CP(f)ᵢⱼ as

where F(f)j is the weight of product item code pⱼ, in company f in features of cost and quantity. At S1225, a determination is made as to whether CP(f)ᵢⱼ converges. If the answer is no, then the process proceeds back to S1224, and if the answer is yes, then the process proceeds to S1226. At S1226, a determination is made as to whether all product item codes in the product category list table of target company 250 have been processed. If the answer is yes, then the process ends. If the answer is no, then the process proceeds back to S1223 for further processing.

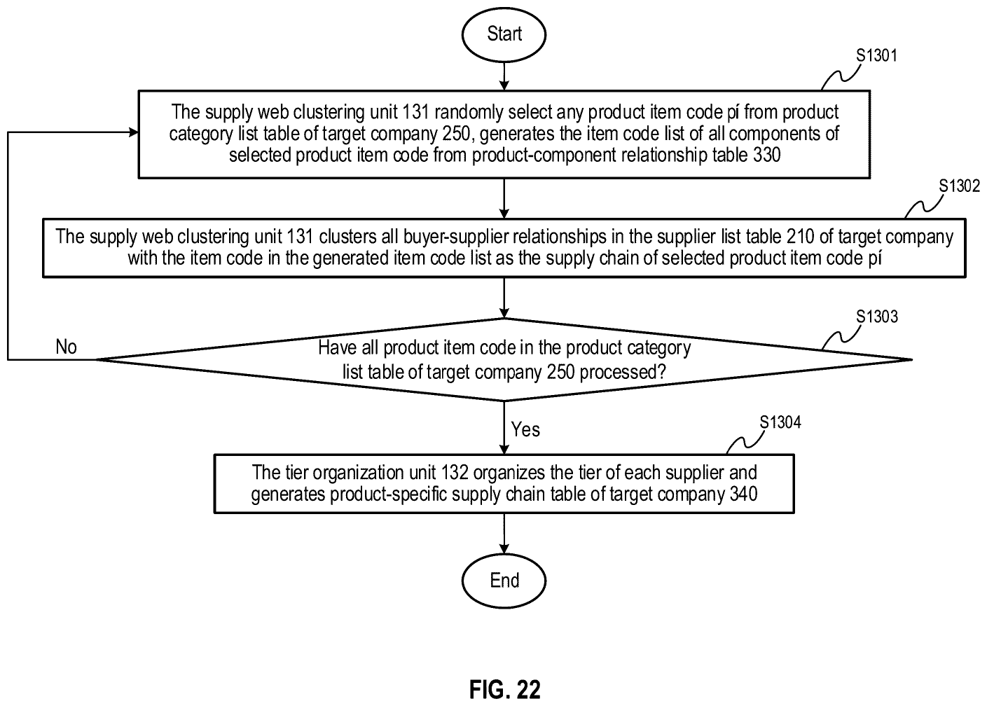

FIG. 22 illustrates a flow chart of product specific supply chain construction server 130, in accordance with an example implementation. At S1301, the supply web clustering unit 131 randomly selects any product item code pⱼ, from product category list table of target company 250, and generates the item code list of all components of selected product item code from product-component relationship table 330. At S1302, the supply web clustering unit 131 clusters all buyer-supplier relationships in the supplier list table 210 of target company with the item code in the generated item code list as the supply chain of selected product item code pⱼ, At S1303, a determination is made as to whether all product item codes in the product category list table of target company 250 have been processed. If the answer is no, the process proceeds back to S1301 for further processing. If the answer is yes, the process proceeds to S1304. At S1304, the tier organization unit 132 organizes the tier of each supplier and generates product-specific supply chain table of target company 340.

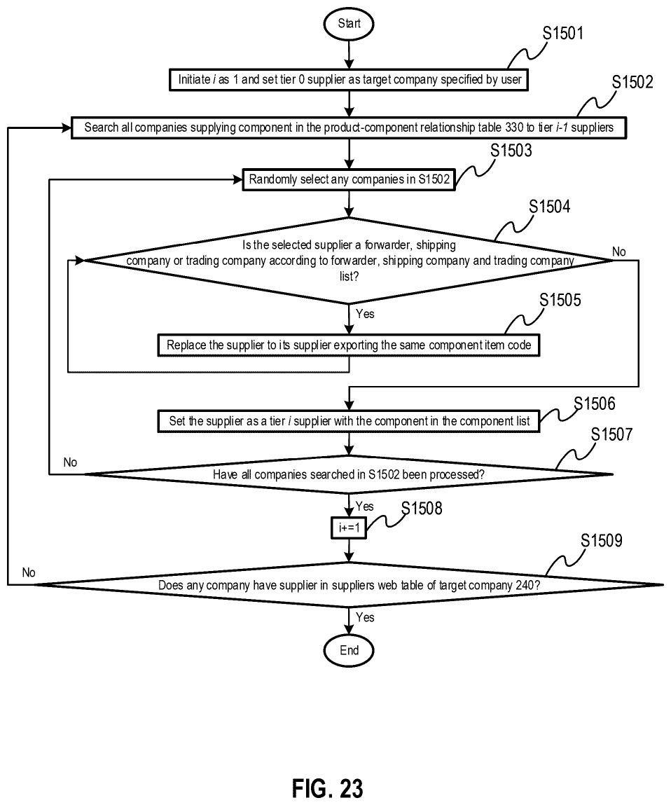

FIG. 23 illustrates a flow chart of a tier organization unit 132, in accordance with an example implementation. At S1501, initiate i as 1 and set tier 0 supplier as target company specified by user. At S1502, search all companies supplying component in the product-component relationship table 330 to tier i−1 suppliers. At S1503, randomly select any companies found through S1502. At S1504, determine if the selected supplier is a forwarder, a shipping company or a trading company by filtering through a forwarder, shipping company and trading company list or having domain experts filter through them. If the answer is yes, the process proceeds to S1505, with the supplier replacing its supplier exporting the same component item code and returning to step S1504. If the answer to step S1504 is no, then the process proceeds to S1506, and the supplier is set as a tier i supplier with the component in the component list, which identifies components with target product having the highest component probability. At S1507, a determination is made as to whether all companies search in S1502 have been processed. If the answer is no, the process returns to S1502 for further processing. If the answer is yes, then i+=1 at S1508. At S1509, it is determined whether any company has supplier in the supply web table of target company 240. If the answer is no, then the process returns to S1502 for further processing. If the answer is yes, then the process comes to an end.

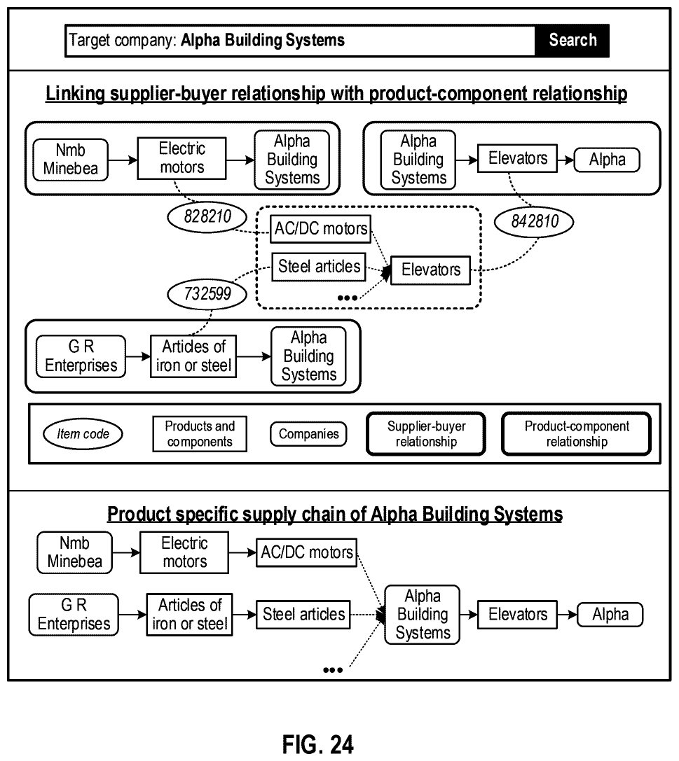

FIG. 24 illustrates an example graphic user interface (GUI) for inputting target company name and displaying the result of linking supplier-buyer relationship with product-component relationship utilizing globally universal item code, in accordance with an example implementation. The GUI generates outputs such as linkage between supplier-buyer relationship with product-component relationship and supply chain for a select target company. User of the system may select a target company in generating outputs associated specifically with the target company. In an example implementation, graphical representations with interflow connections are displayed on the GUI.

The foregoing example implementation may have various benefits and advantages. For example, ease in the construction of product-specific supply chain with both supplier-buyer relationship and product-component relationship. In addition, generation of clear and simple company specific tree construction of supply chain that is easy to understand. Furthermore, tiers of suppliers and components can be flexibly organized by each company to generate company specific construction of supply chain.

### Embodiment 2

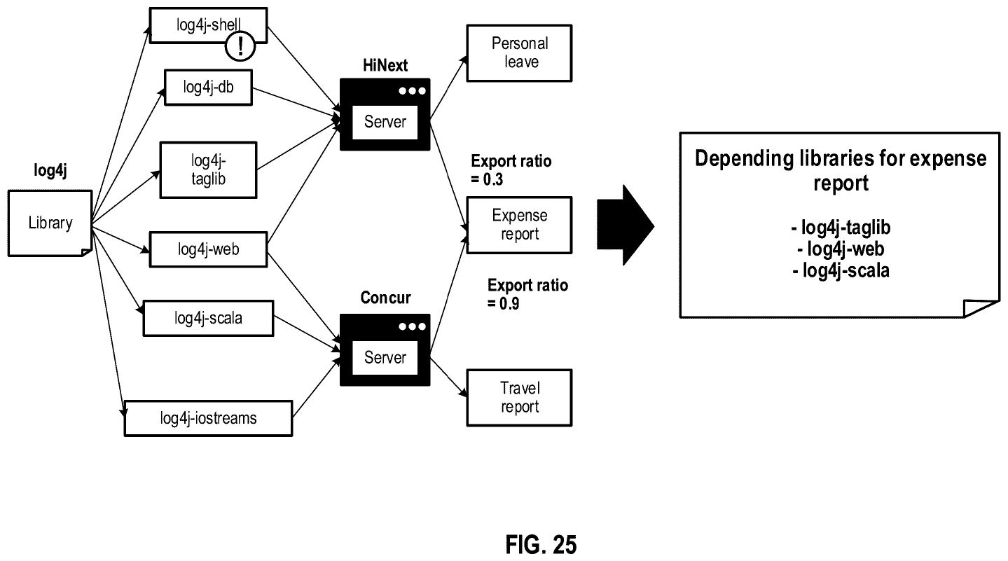

FIG. 25 illustrates an example software-module chain information flow decomposition, in accordance with an example implementation. Instead of supply chain construction, the underlying mapping and relationship generation are utilized in a software-module chain construction method. Software vulnerabilities have increased significantly due to the use of open-source software (OSS). For instance, log 4j, an Apache open source logging library for java, contains modules that are known to be vulnerable. As a result, servers including software/functions dependent on log 4j's vulnerable modules could be hacked. However, identifying all software/functions affected by vulnerable library (e.g. log 4j) module requires tracing software-module dependencies.

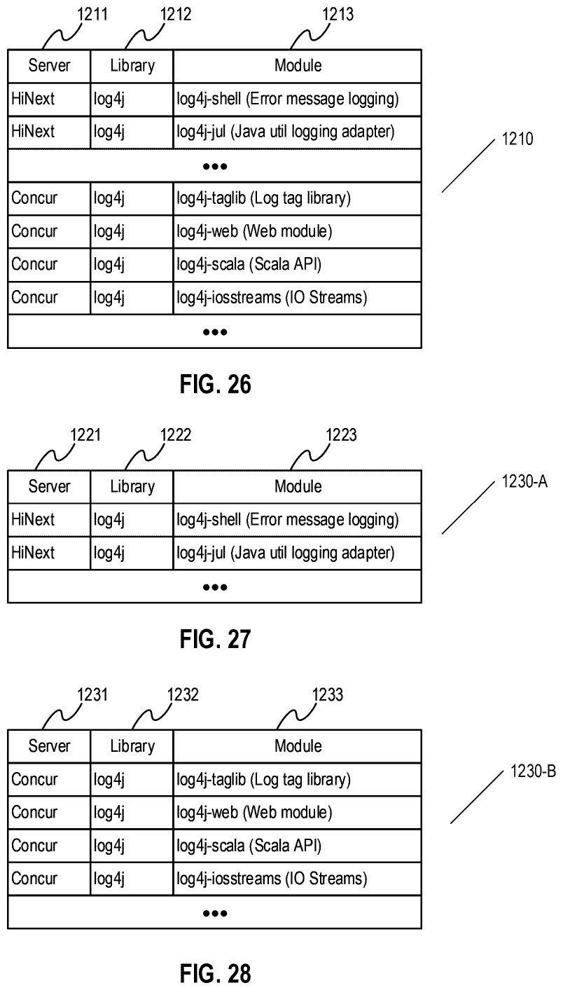

FIG. 26 illustrates an example server-library dependency table 1210, in accordance with an example implementation. The server-library dependency table 1210 is similar to the supplier list table 210 of the first embodiment, and stores information involving server information 1211, library information 1212, and module information 1213. The stored information allows for tracing and establishing relationships between the various components. Taking row one as example, it shows that module “log 4j-shell (Error message logging)” is associated with library “log 4j” and server “HiNext”.

FIG. 27 illustrates an example server-library dependency table of HiNext 1230-A, in accordance with an example implementation. The server-library dependency table of HiNext 1230-A is similar to the buyer-supplier relationships table of Alpha Building Systems 230-A of the first embodiment, and stores dependency information pertaining to server HiNext, comprising server information 1221, library information 1222, and module information 1223. Taking row one as example, it shows that module “log 4j-shell (Error message logging)” is associated with library “log 4j” and “HiNext” is identified as the server.

FIG. 28 illustrates an example server-library dependency table of Concur 1230-B, in accordance with an example implementation. The server-library dependency table of Concur 1230-B is similar to the buyer-supplier relationships table of Alpha High Tech 230-B of the first embodiment. The server-library dependency table of Concur 1230-B is similar to the server-library dependency table of HiNext 1230-A, however, the server-library dependency table of Concur 1230-B stores information that pertain to the server Concur. The server-library dependency table of Concur 1230-B stores information involving server information 1231, library information 1232, and module information 1233.

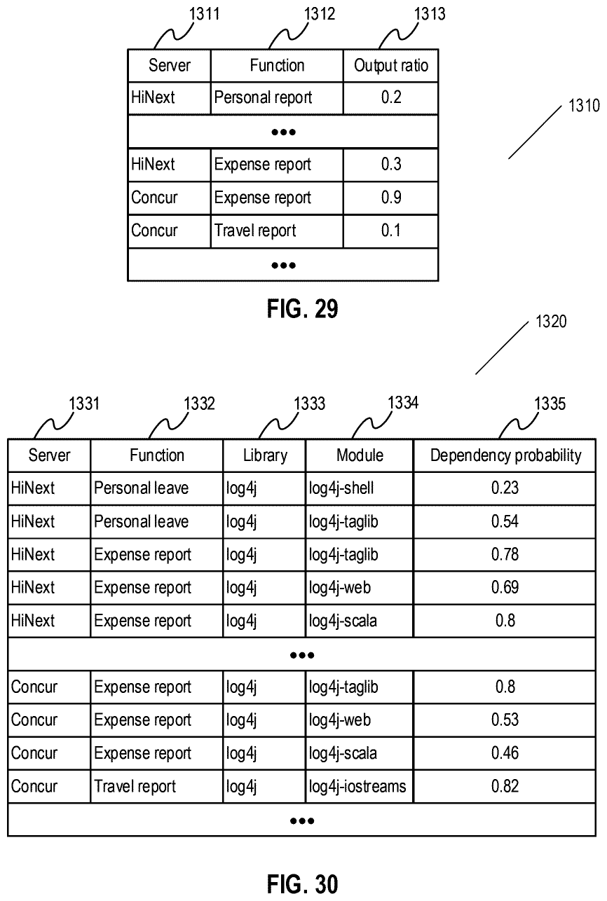

FIG. 29 illustrates an example sever function output ratio table 1310, in accordance with an example implementation. The sever function output ratio table 1310 is similar to the sales ratio table 310 of the first embodiment, and stores information showing relationship between server information 1311, function information 1312, and output ratio 1313. The output ratio 1313 is calculated using the established server-library relationship from the server-library dependency table 1210 and server-function relationship.

FIG. 30 illustrates an example server function-library module dependency probability table 1320, in accordance with an example implementation. The server function-library module dependency probability table 1320 is similar to the component probability table 320 of the first embodiment, and stores information involving server information 1331, function information 1332, library information 1333, module information 1334, and dependency probability 1335.

For server f depending on M library modules c₁, c₂, . . . , c_{M} and N software/functions p₁, p₂, . . . , p_{N}, calculate the Dependency Probability DNA(f)ᵢⱼ that cᵢ is the necessary library module of software/function pⱼ (e.g. expense report), where i∈1, 2, . . . , M and j∈1, 2, . . . , N. Fⱼ refers to the set of servers with software/function pⱼ, including target server.

First, D_{P}′(f)ᵢⱼ is initialized to be the output ratio of pⱼ (e.g., expense report) to all function output of server f. This is then followed by updating

$$DP ’ {( f )}_{i j} = \frac{{\sum }_{f ∈ {F}_{j}}^{f} {DP ( f )}_{ij}}{{\sum }_{k ∈ 1 , 2 , … , N}^{k} {\sum }_{f ∈ {F}_{j}}^{f} {DP ( f )}_{i k}}$$

iteratively to increase the dependency probability of library module commonly used by servers having function pⱼ (e.g., expense report) until convergence.

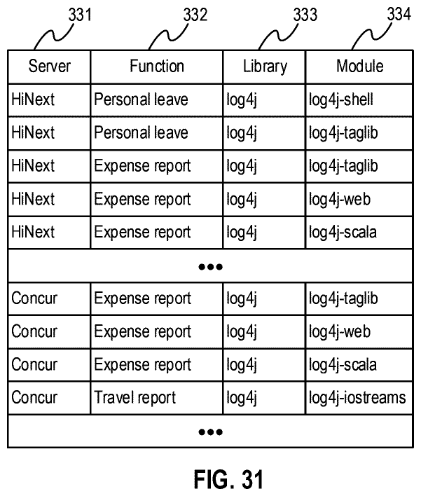

FIG. 31 illustrates an example server function-library module relationship table 1330, in accordance with an example implementation. The server function-library module relationship table 1330 is similar to the product-component relationship table 330 of the first embodiment, and stores information showing the relationship between the various servers, functions, library, and modules. Similar to the first embodiment, a graphic user interface (GUI) may be used for inputting target server or function and displaying the result of linking server function-library module relationship. In an example implementation, graphical representations with interflow connections are displayed on the GUI.

### Embodiment 3

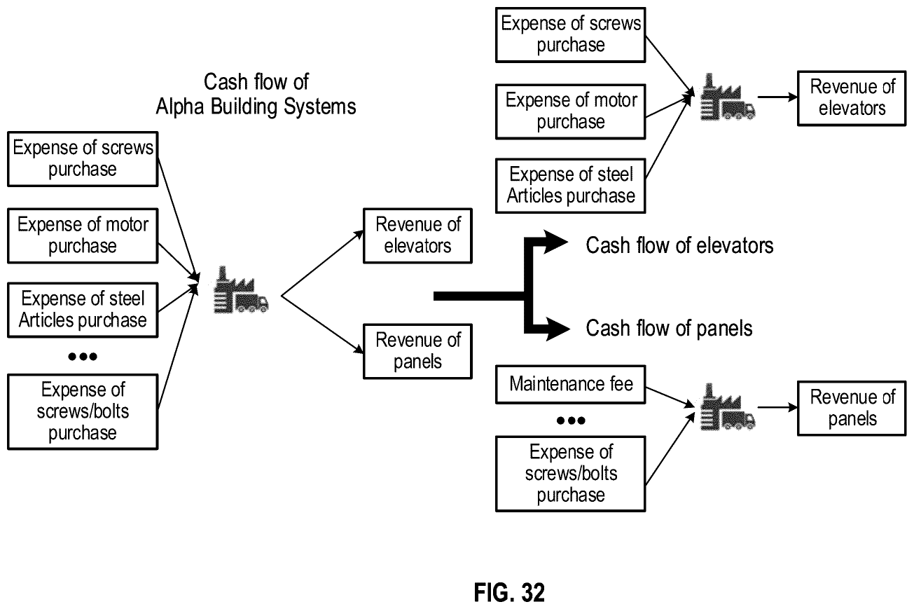

FIG. 32 illustrates an example of cash flow decomposition, in accordance with an example implementation. In addition to supply chain construction and software-module chain construction, the underlying mapping and relationship generation may be utilized in a cash flow monitoring method. Currently, loans are generally decided by borrowers' rating. Thus, banks rate the financial obligation of borrowers. Hence, loan acquisition process for SME (Small and Mid-size Enterprise) can be difficult even when they have good business opportunities. Therefore, in supply chain financing, credit rating based on business instead of borrower is required. However, it requires the cash flow monitoring of each business instead of the borrower.

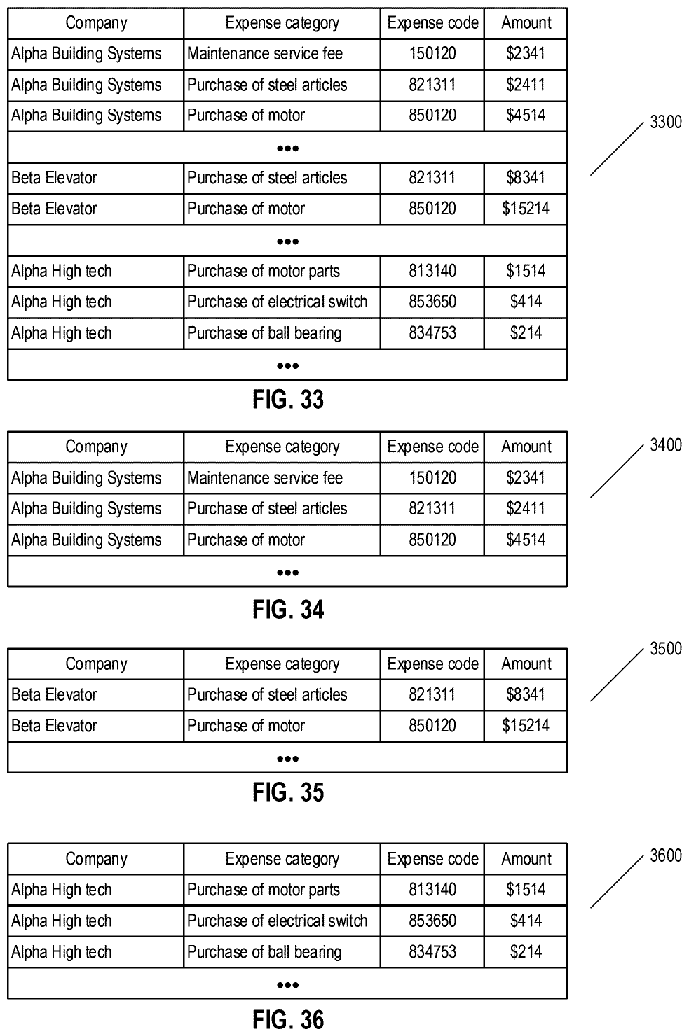

FIG. 33 illustrates an example expense table 3300, in accordance with an example implementation. The expense table 3300 stores information involving company information, expense category, expense code, and associated amount. The stored information allows for tracing and establishing relationships between the various expenses and associated companies or vendors. Taking row one as example, it shows that company “Alpha Building Systems” has spent an amount “$2341” for the expense category “maintenance service fee” under expense code “150120”.

FIG. 34 illustrates an example expense table for Alpha Building Systems 3400, in accordance with an example implementation. The expense table for Alpha Building Systems 3400 is similar to the expense table 3300, but stores only expense information related to Alpha Building Systems. The expense table for Alpha Building Systems 3400 stores information pertaining to the company, Alpha Building Systems, comprising company information, expense category, expense code, and amount.

FIG. 35 illustrates an example expense table for Beta Elevator 3500, in accordance with an example implementation. The expense table for Beta Elevator 3500 is similar to the expense table 3300, but stores only expense information related to Beta Elevator. The expense table for Beta Elevator 3500 stores information pertaining to the company Beta Elevator, comprising company information, expense category, expense code, and amount.

FIG. 36 illustrates an example expense table for Alpha High Tech 3600, in accordance with an example implementation. The expense table for Alpha High Tech 3600 is similar to the expense table 3300, but stores only expense information related to Alpha High Tech. The expense table for Alpha High Tech 3600 stores information pertaining to the company, Alpha High Tech, comprising company information, expense category, expense code, and amount.

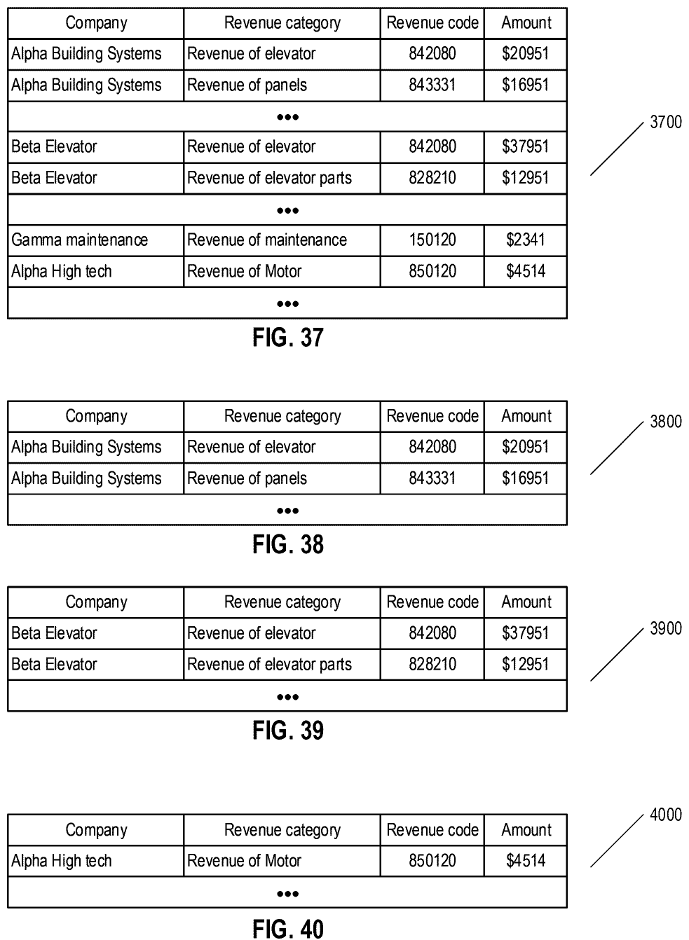

FIG. 37 illustrates an example revenue table 3700, in accordance with an example implementation. The revenue table 3700 stores information involving company information, revenue category, revenue code, and associated amount. The stored information allows for tracing and establishing relationships between the various revenues and associated companies. Taking row one as example, it shows that company “Alpha Building Systems” has spent an amount “$20951” for the revenue category “revenue of elevator” under expense code “842080”.

FIG. 38 illustrates an example revenue table for Alpha Building Systems 3800, in accordance with an example implementation. The revenue table for Alpha Building Systems 3800 is similar to the revenue table 3700, but stores only revenue information related to Alpha Building Systems. The revenue table for Alpha Building Systems 3800 stores information pertaining to the company Alpha Building Systems, comprising company information, revenue category, revenue code, and amount.

FIG. 39 illustrates an example revenue table for Beta Elevator 3900, in accordance with an example implementation. The revenue table for Beta Elevator 3900 is similar to the revenue table 3700, but stores only revenue information related to Beta Elevator. The revenue table for Beta Elevator 3900 stores information pertaining to the company Beta Elevator, comprising company information, revenue category, revenue code, and amount.

FIG. 40 illustrates an example revenue table for Alpha High Tech 4000, in accordance with an example implementation. The revenue table for Alpha High Tech 4000 is similar to the revenue table 3700, but stores only revenue information related to Alpha High Tech. The revenue table for Alpha High Tech 4000 stores information pertaining to the company, Alpha High Tech, comprising company information, revenue category, revenue code, and amount.

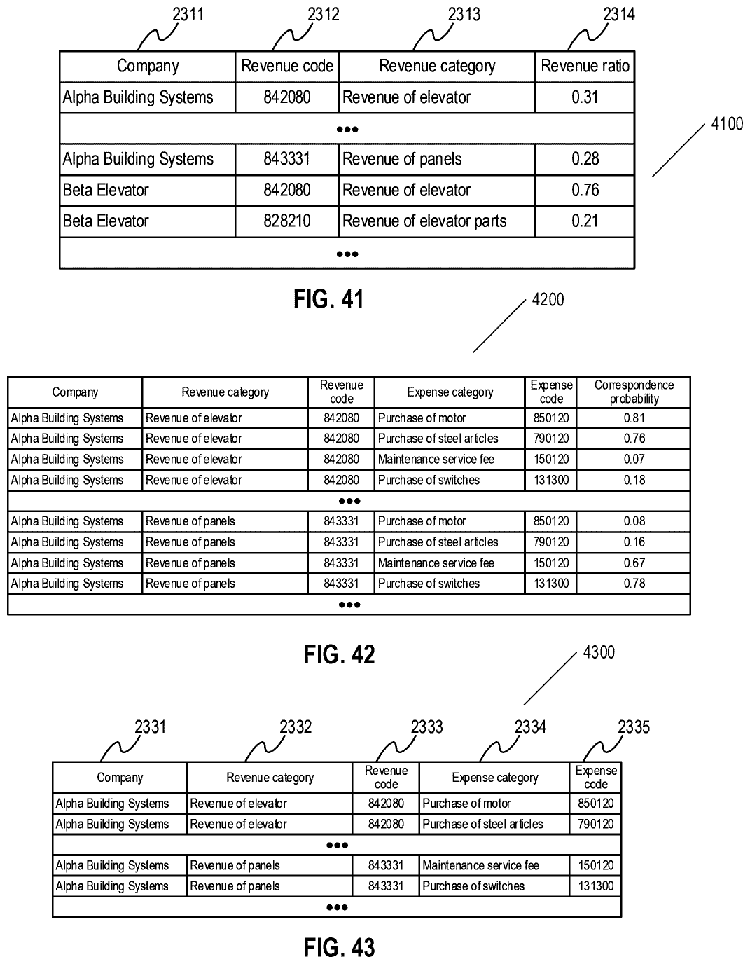

FIG. 41 illustrates an example revenue ratio table 4100, in accordance with an example implementation. The revenue ratio table 4100 is similar to the sales ratio table 310 of the first embodiment, and stores information showing relationship between company information 2311, revenue code 2312, revenue category 2313, and revenue ratio 2314. The revenue ratio 2314 is calculated using the established expense information and revenue information contained within tables of FIGS. 33-40.

FIG. 42 illustrates an example revenue-expense correspondence probability table 4200, in accordance with an example implementation. The revenue-expense correspondence probability table 4200 is similar to the component probability table 320 of the first embodiment, and stores information involving company information, revenue category, revenue code, expense category, expense code and correspondence probability.

For company f with M expenses c₁, c₂, . . . , c_{M} and N income p₁, p₂, . . . , p_{N}, calculate the Correspondence Probability CT(f)ᵢⱼ that cᵢ is the expense of income pⱼ (e.g. income of elevator maintenance), where i∈1, 2, . . . , M and j∈1, 2, . . . , N. Fⱼ refers to the set of companies having income pⱼ (e.g. companies having income of elevator maintenance), including target company.

Initial setting: First, CP′(f)ᵢⱼ is initialized to be the revenue ratio of product pⱼ to all revenue of factory f. This is then followed by updating

$$CP ’ {( f )}_{i j} = \frac{{\sum }_{f ∈ {F}_{j}}^{f} {CP ( f )}_{ij}}{{\sum }_{k ∈ 1 , 2 , … , N}^{k} {\sum }_{f ∈ {F}_{j}}^{f} C {P ( f )}_{i k}}$$

iteratively to increase the expense-revenue probability of expenses commonly paid by companies having the revenue of pⱼ until convergence.

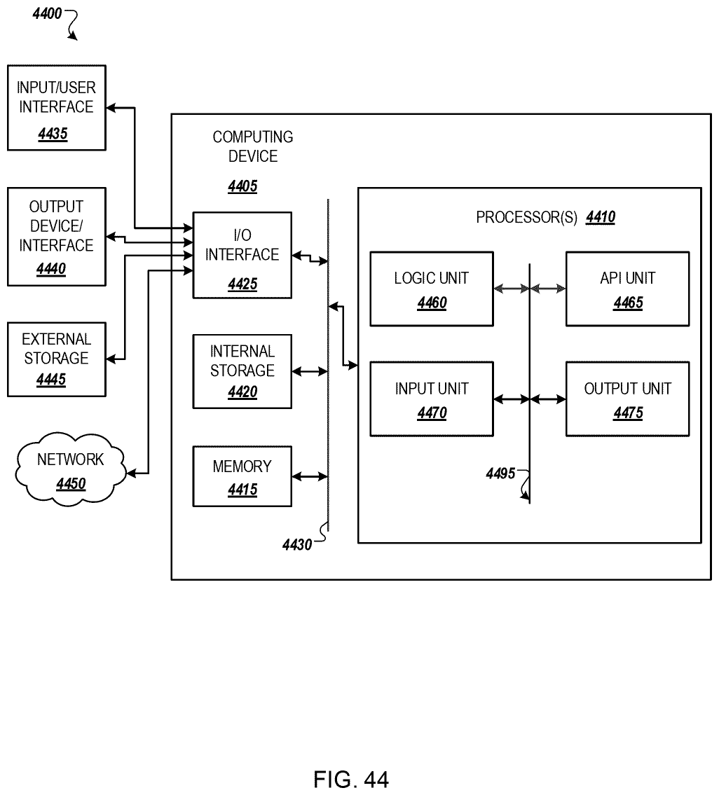

FIG. 43 illustrates an example revenue-expense relationship table 4300, in accordance with an example implementation. The revenue-expense relationship table 4300 is similar to the product-component relationship table 330 of the first embodiment, and stores information showing the relationship between company information 2331, revenue category 2332, revenue code 2333, expense category 2334, and expense code 2335. Similar to the first embodiment, a graphic user interface (GUI) may be used for inputting target company and displaying the result of linking revenue-expense relationship. In an example implementation, graphical representations with interflow connections are displayed on the GUI.

FIG. 44 illustrates an example computing environment with an example computer device suitable for use in some example implementations. Computer device 4405 in computing environment 4400 can include one or more processing units, cores, or processor(s) 4410, memory 4415 (e.g., RAM, ROM, and/or the like), internal storage 4420 (e.g., magnetic, optical, solid-state storage, and/or organic), and/or IO interface 4425, any of which can be coupled on a communication mechanism or bus 4430 for communicating information or embedded in the computer device 4405. IO interface 4425 is also configured to receive images from cameras or provide images to projectors or displays, depending on the desired implementation.

Computer device 4405 can be communicatively coupled to input/user interface 4435 and output device/interface 4440. Either one or both of the input/user interface 4435 and output device/interface 4440 can be a wired or wireless interface and can be detachable. Input/user interface 4435 may include any device, component, sensor, or interface, physical or virtual, that can be used to provide input (e.g., buttons, touch-screen interface, keyboard, a pointing/cursor control, microphone, camera, braille, motion sensor, accelerometer, optical reader, and/or the like). Output device/interface 4440 may include a display, television, monitor, printer, speaker, braille, and/or the like. In some example implementations, input/user interface 4435 and output device/interface 4440 can be embedded with or physically coupled to the computer device 4405. In other example implementations, other computer devices may function as or provide the functions of input/user interface 4435 and output device/interface 4440 for a computer device 4405.

Examples of computer device 4405 may include, but are not limited to, highly mobile devices (e.g., smartphones, devices in vehicles and other machines, devices carried by humans and animals, and the like), mobile devices (e.g., tablets, notebooks, laptops, personal computers, portable televisions, radios, and the like), and devices not designed for mobility (e.g., desktop computers, other computers, information kiosks, televisions with one or more processors embedded therein and/or coupled thereto, radios, and the like).

Computer device 4405 can be communicatively coupled (e.g., via IO interface 4425) to external storage 4445 and network 4450 for communicating with any number of networked components, devices, and systems, including one or more computer devices of the same or different configuration. Computer device 4405 or any connected computer device can be functioning as, providing services of, or referred to as a server, client, thin server, general machine, special-purpose machine, or another label.

IO interface 4425 can include but is not limited to, wired and/or wireless interfaces using any communication or IO protocols or standards (e.g., Ethernet, 802.11x, Universal System Bus, WiMax, modem, a cellular network protocol, and the like) for communicating information to and/or from at least all the connected components, devices, and network in computing environment 4400. Network 4450 can be any network or combination of networks (e.g., the Internet, local area network, wide area network, a telephonic network, a cellular network, satellite network, and the like).

Computer device 4405 can use and/or communicate using computer-usable or computer readable media, including transitory media and non-transitory media. Transitory media include transmission media (e.g., metal cables, fiber optics), signals, carrier waves, and the like. Non-transitory media include magnetic media (e.g., disks and tapes), optical media (e.g., CD ROM, digital video disks, Blu-ray disks), solid-state media (e.g., RAM, ROM, flash memory, solid-state storage), and other non-volatile storage or memory.

Computer device 4405 can be used to implement techniques, methods, applications, processes, or computer-executable instructions in some example computing environments. Computer-executable instructions can be retrieved from transitory media, and stored on and retrieved from non-transitory media. The executable instructions can originate from one or more of any programming, scripting, and machine languages (e.g., C, C++, C #, Java, Visual Basic, Python, Perl, JavaScript, and others).

Processor(s) 4410 can execute under any operating system (OS) (not shown), in a native or virtual environment. One or more applications can be deployed that include logic unit 4460, application programming interface (API) unit 4465, input unit 4470, output unit 4475, and inter-unit communication mechanism 4495 for the different units to communicate with each other, with the OS, and with other applications (not shown). The described units and elements can be varied in design, function, configuration, or implementation and are not limited to the descriptions provided. Processor(s) 4410 can be in the form of hardware processors such as central processing units (CPUs) or in a combination of hardware and software units.

In some example implementations, when information or an execution instruction is received by API unit 4465, it may be communicated to one or more other units (e.g., logic unit 4460, input unit 4470, output unit 4475). In some instances, logic unit 4460 may be configured to control the information flow among the units and direct the services provided by API unit 4465, the input unit 4470, the output unit 4475, in some example implementations described above. For example, the flow of one or more processes or implementations may be controlled by logic unit 4460 alone or in conjunction with API unit 4465. The input unit 4470 may be configured to obtain input for the calculations described in the example implementations, and the output unit 4475 may be configured to provide an output based on the calculations described in example implementations.

Processor(s) 4410 can be configured to, for receipt of a search for a specified company, obtain a supplier list and sales information for a plurality of companies associated with the specified company as illustrated in FIGS. 4 and 10. The processor(s) 4410 may also be configured to trace purchased components and suppliers of the purchased components by item category from supplier-buyer relationship in the supplier list to generate a supply web as illustrated in FIGS. 5-7 and. The processor(s) 4410 may also be configured to calculate sales ratios using the supplier-buyer relationship and the sales information as illustrated in FIGS. 11 and 20. The processor(s) 4410 may also be configured to calculate component probability of the purchased components in association with a plurality of products by using the sales ratios, wherein each of the plurality of product is formed from a number of the purchased components as illustrated in FIG. 12. The processor(s) 4410 may also be configured to estimate product-component relationship using the supply web and the component probability for the plurality of products and the purchased components as illustrated in FIG. 15. The processor(s) 4410 may also be configured to generate product specific supply chain associated with the purchased components and the suppliers for the specified company as illustrated in FIG. 15. The processor(s) 4410 may also be configured to display the product specific supply chain and the supplier-buyer relationship on a graphic user interface (GUI) as illustrated in in FIG. 24.

Processor(s) 4410 can be configured to obtain a server-library dependency information for a plurality of servers associated with a library as illustrated in FIGS. 26-28. The processor(s) 4410 may also be configured to trace the plurality of servers and a plurality of modules associated with the library from server-library relationship in the server-library dependency information as illustrated in FIGS. 26-28. The processor(s) 4410 may also be configured to calculate output ratios using the server-library relationship and a plurality of server functions as illustrated in FIG. 29. The processor(s) 4410 may also be configured to calculate dependency probability of the plurality of servers in association with the plurality of server functions, the plurality of servers, and the plurality of modules as illustrated in FIG. 30. The processor(s) 4410 may also be configured to generate server function-library module relationship associated with the server functions and the library as illustrated in FIG. 31. The processor(s) 4410 may also be configured to display the server function-library module relationship on a graphic user interface (GUI) as illustrated in FIG. 24.

Processor(s) 4410 can be configured to obtain expense information and revenue information associated with a company as illustrated in FIGS. 33-40. The processor(s) 4410 may also be configured to calculate revenue ratios using the expense information and the revenue information as illustrated in FIG. 41. The processor(s) 4410 may also be configured to calculate correspondence probability of expenses of purchased components in association with revenues of products by using the revenue ratios as illustrated in FIG. 42. The processor(s) 4410 may also be configured to generate revenue-expense relationship associated with the expenses of purchased components and the revenues of products of the company as illustrated in FIG. 43. The processor(s) 4410 may also be configured to display the revenue-expense relationship on a graphic user interface (GUI) as illustrated in FIG. 24.

Some portions of the detailed description are presented in terms of algorithms and symbolic representations of operations within a computer. These algorithmic descriptions and symbolic representations are the means used by those skilled in the data processing arts to convey the essence of their innovations to others skilled in the art. An algorithm is a series of defined steps leading to a desired end state or result. In example implementations, the steps carried out require physical manipulations of tangible quantities for achieving a tangible result.

Unless specifically stated otherwise, as apparent from the discussion, it is appreciated that throughout the description, discussions utilizing terms such as “processing,” “computing,” “calculating,” “determining,” “displaying,” or the like, can include the actions and processes of a computer system or other information processing device that manipulates and transforms data represented as physical (electronic) quantities within the computer system's registers and memories into other data similarly represented as physical quantities within the computer system's memories or registers or other information storage, transmission or display devices.

Example implementations may also relate to an apparatus for performing the operations herein. This apparatus may be specially constructed for the required purposes, or it may include one or more general-purpose computers selectively activated or reconfigured by one or more computer programs. Such computer programs may be stored in a computer readable medium, such as a computer readable storage medium or a computer readable signal medium. A computer readable storage medium may involve tangible mediums such as, but not limited to optical disks, magnetic disks, read-only memories, random access memories, solid-state devices, and drives, or any other types of tangible or non-transitory media suitable for storing electronic information. A computer readable signal medium may include mediums such as carrier waves. The algorithms and displays presented herein are not inherently related to any particular computer or other apparatus. Computer programs can involve pure software implementations that involve instructions that perform the operations of the desired implementation.

Various general-purpose systems may be used with programs and modules in accordance with the examples herein, or it may prove convenient to construct a more specialized apparatus to perform desired method steps. In addition, the example implementations are not described with reference to any particular programming language. It will be appreciated that a variety of programming languages may be used to implement the teachings of the example implementations as described herein. The instructions of the programming language(s) may be executed by one or more processing devices, e.g., central processing units (CPUs), processors, or controllers.

As is known in the art, the operations described above can be performed by hardware, software, or some combination of software and hardware. Various aspects of the example implementations may be implemented using circuits and logic devices (hardware), while other aspects may be implemented using instructions stored on a machine-readable medium (software), which if executed by a processor, would cause the processor to perform a method to carry out implementations of the present application. Further, some example implementations of the present application may be performed solely in hardware, whereas other example implementations may be performed solely in software. Moreover, the various functions described can be performed in a single unit, or can be spread across a number of components in any number of ways. When performed by software, the methods may be executed by a processor, such as a general-purpose computer, based on instructions stored on a computer readable medium. If desired, the instructions can be stored on the medium in a compressed and/or encrypted format.

Moreover, other implementations of the present application will be apparent to those skilled in the art from consideration of the specification and practice of the teachings of the present application. Various aspects and/or components of the described example implementations may be used singly or in any combination. It is intended that the specification and example implementations be considered as examples only, with the true scope and spirit of the present application being indicated by the following claims.

What is claimed is:

1. A supply chain construction method, comprising:
for receipt of a search for a specified company:
obtaining a supplier list and sales information for a plurality of companies associated with the specified company;
tracing purchased components and suppliers of the purchased components by item category from supplier-buyer relationship in the supplier list to generate a supply web;
calculating sales ratios using the supplier-buyer relationship and the sales information;
calculating component probability of the purchased components in association with a plurality of products by using the sales ratios, wherein each of the plurality of product is formed from a number of the purchased components;
estimating product-component relationship using the supply web and the component probability for the plurality of products and the purchased components; and
generating product specific supply chain associated with the purchased components and the suppliers for the specified company.

2. The method of claim 1, wherein the obtaining supplier list and sales information for the plurality of companies associated with the specified company comprises:
generating the supplier list by compiling first information associating the suppliers, buyers of the purchased components, the item category of the purchased components, and item code; and
generating the sales information by compiling second information associating the suppliers, the item code, the item category, unit associated with purchased component, quantity associated with purchased component, and price associated with purchased component.

3. The method of claim 1, further comprising displaying the product specific supply chain and the supplier-buyer relationship on a graphic user interface (GUI).

4. The method of claim 1, wherein:
the supplier list includes information of the suppliers, buyers and the item category of the purchased components; and
the sales information includes at least one of amount or price associated with purchased components.

5. The method of claim 1, wherein the estimating the product-component relationship comprises estimating the product-component relationship for ones of the purchased components having highest component probability associated with the plurality of products.

6. The method of claim 1, wherein the calculating component probability of the purchased components in association with the plurality of products by using the sales ratios comprises:
initializing the component probability of each product category as sales ratio of the product category;
updating the component probability of the product category by adding probability of components commonly purchased by companies supplying the product category to the component probability of the product category; and
iteratively updating the component probability until a convergence is reached.

7. The method of claim 1, wherein the estimating product-component relationship using the supply web and the component probability for the plurality of products and the purchased components comprises:
linking the supplier-buyer relationship in the supply web with the component probability to establish supplier-buyer-product-component relationship for the plurality of products and the purchased components; and
organizing the established supplier-buyer-product-component relationship into tiers.

8. A software-module chain construction method, comprising:
obtaining a server-library dependency information for a plurality of servers associated with a library;
tracing the plurality of servers and a plurality of modules associated with the library from server-library relationship in the server-library dependency information;
calculating output ratios using the server-library relationship and a plurality of server functions;
calculating dependency probability of the plurality of servers in association with the plurality of server functions, the plurality of servers, and the plurality of modules; and
generating server function-library module relationship associated with the server functions and the library.

9. The method of claim 8 wherein the obtaining the server-library dependency information for the plurality of servers associated with the library comprises obtaining information of a plurality of modules, library associated with the plurality of the modules, and the plurality of servers associated with the plurality of modules.

10. The method of claim 8, further comprising displaying the server function-library module relationship on a graphic user interface (GUI).

11. The method of claim 8, wherein the obtaining the server-library dependency information for the plurality of servers associated with the library comprises obtaining a plurality of sub-server-library dependency information, each of the plurality of sub-server-library dependency information is associated with a server of the plurality of servers respectively.

12. The method of claim 8, wherein the calculating dependency probability of the plurality of servers in association with the plurality of server functions, the plurality of servers, and the plurality of modules comprises:
initializing the dependency probability of each entry of the server function-library module relationship as output ratio of associated server-function;
updating the dependency probability of each entry of the server function-library module relationship by adding probability of library module commonly used by the plurality of servers to the dependency probability; and
iteratively updating the dependency probability until a convergence is reached.

13. A cash flow monitoring method, comprising:
obtaining expense information and revenue information associated with a company;
calculating revenue ratios using the expense information and the revenue information;
calculating correspondence probability of expenses of purchased components in association with revenues of products by using the revenue ratios; and
generating revenue-expense relationship associated with the expenses of purchased components and the revenues of products of the company.

14. The method of claim 13, wherein the obtaining expense information and revenue information associated with the company comprises:
obtaining expense information associated with the purchased components, the purchased components are sourced from at least one vendor; and
obtaining revenue information associated with the products, the products are produced using the purchased components.

15. The method of claim 13, further comprising displaying the revenue-expense relationship on a graphic user interface (GUI).

16. The method of claim 13, wherein:
the expense information comprises information of expense category, expense amount associated with the expense category, and one of the company or at least one vendor; and
the revenue information comprises information of revenue category, revenue amount associated with the revenue category, and one of the company or the at least one vendor.

17. The method of claim 13, wherein the calculating correspondence probability of the expenses of purchased components in association with the revenues of products by using the revenue ratios comprises:
initializing the correspondence probability of each expense category as the revenue ratio of the revenue category;
updating the correspondence probability of the expense category by adding probability of expenses commonly paid by companies associated with the revenues of products to the correspondence probability of the expense category; and
iteratively updating the correspondence probability until a convergence is reached.
